(19) United States
(12) Patent Application Publication
(10) Pub. No.: US 2008/0084415 A1
(43) Pub. Date: Apr. 10, 2008

(54) Orientation of 3-dimensional displays as a function of the regions to be examined

(76) Inventor: Lutz Gundel, (US)

Correspondence Address: BRINKS HOFER GILSON & LIONE, P.O. BOX 10395, CHICAGO, IL, 60610, US

(21) Appl. No.: 11/544,795

(22) Filed: Oct. 6, 2006

(51) Int. Cl. G06T 15/20

(52) U.S. Cl. 345/427

(57) ABSTRACT

A system and method provide automatic image visualization of an object of interest. One or more data sets may include image data of the object of interest. The image data may include medical images and the object of interest may be an anatomical structure or region. One or more of the data sets may be analyzed to characterize the object. Subsequently, without requiring any user input, the image visualization may include automatically selecting a standard view at which to display the object of interest. For instance, based upon object classification, a predetermined orientation at which to display the object may be automatically selected. Additionally, to enhance the resolution of images displayed, the object of interest may be automatically resized or otherwise adapted based upon characteristics/settings of a display. For instance, the object of interest may be automatically resized to maximize the size of the object displayed within a window.

### BACKGROUND

The present embodiments relate generally to the display of images on a display screen. In particular, the present embodiments relate to automatically determining a standard view corresponding to an object of interest.

Conventional systems may perform operations on data sets to produce two or three dimensional images for medical diagnosis. The images may be visualized on a display screen by using various methods. Known visualization methods include multi-planar reconstruction, maximum intensity projection, volume rendering, and surface shading. In the case of vessels being displayed, a MPR (multi-planar reformatted) image perpendicular to each actual vessel position may be generated. Additionally, virtual flight or movement through hollow organs may be simulated.

To rotate and alter the multi-dimensional images of the objects displayed on the screen, conventional systems require that manual operations be performed or commands otherwise be entered by a user. For instance, a typical display may include a two dimensional image of an object. To locate an anatomy or area of interest, the object may be rotated in one or more dimensions via manually entered user commands. Subsequently, for enhanced resolution, user commands also may be manually entered that enlarge the size of the object displayed. However, manually entering commands to rotate and/or alter the size of the object of interest displayed may be cumbersome and inefficient.

### BRIEF SUMMARY

By way of introduction, the embodiments described below include methods, processes, apparatuses, instructions, or systems for providing automatic orientation and/or resizing of an object of interest to be displayed on a display screen. The object of interest may be contained within images associated with one or more image data sets. Based upon the type of an object of interest determined to be contained within the image data, images of the object of interest may be automatically oriented to a predetermined orientation. For instance, an object of interest shown within an image may be characterized as corresponding to a specific type of anatomical structure. That type of anatomical structure may have an associated predetermined orientation at which to display the corresponding image(s). The image of the object to be displayed may be automatically resized or otherwise altered before being displayed such that the resolution of the object displayed is enhanced.

In a first aspect, a data processing system provides automatic image visualization. The system includes a processor operable to characterize an object of interest shown within an image by type and automatically derive a standard view at which the object of interest is to be displayed based upon the type. The system also includes a display screen operable to display the standard view of the object of interest.

In a second aspect, a method provides automatic image visualization. The method includes automatically deriving a standard view of an object of interest to be displayed from a plurality of image data sets, each of the plurality of image data sets includes data from which images of the object of interest may be generated. The method also includes displaying the standard view of the object of interest.

In a third aspect, a method provides automatic image visualization. The method includes automatically characterizing an object of interest by type based upon corresponding image data, automatically selecting a predetermined orientation of the object of interest at which the object of interest is to be displayed based upon the type, and displaying the object of interest at the predetermined orientation.

In a fourth aspect, a computer-readable medium having instructions executable on a computer and stored thereon is described. The instructions include determining the dimensions of an object of interest contained within image data. The instructions also include automatically resizing the object of interest based upon the dimensions determined before the object of interest is displayed to enhance a resolution of the object of interest once displayed.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The present embodiments will become more fully understood from the detailed description given herein below and the accompanying drawings which are given by way of illustration only, and are not limitative of the present invention, and wherein:

FIG. 1 is an exemplary method of automatic image visualization;

FIG. 2 is an exemplary display of an object of interest being shown at a specific orientation;

FIGS. 3 and 4 are exemplary user interfaces for automatic image visualization; and

FIG. 5 is an exemplary data processing system operable to provide automatic image visualization.

### DETAILED DESCRIPTION OF THE DRAWINGS AND PRESENTLY PREFERRED EMBODIMENTS

The embodiments described herein include methods, processes, apparatuses, instructions, or systems for providing automatic orientation and sizing of one or more objects of interest to be displayed on a display screen. An object of interest may be represented within image data and automatically classified by type. The type of an object of interest may be automatically determined by a processor performing operations on one or more data sets containing image data of the object of interest. Based upon the type of the object of interest identified, the object displayed may be automatically rotated and/or adapted to a “standard” view.

The standard view may be an image of the object orientated to a desired axis and/or perspective. Alternatively, the standard view may be a view of the object automatically resized or otherwise altered to enhance resolution. For instance, the object displayed may be enlarged or reduced to enhance the resolution of the object on the display, such as to fully utilize the available size of the display and/or to enlarge a small object of interest. The standard view may include altering settings of the display, such as contrast and brightness, based upon the characteristics and/or quality of the image data. Other standard views may be generated.

The method of image visualization of objects of interest may automatically generate and display one or more objects of interest on a display screen without requiring user commands to be manually entered. The method of image visualization may use a “complete” data set of images to generate and display a subset of images corresponding to a specific object of interest. The displayed subset of images may be repeatedly replicated for a given complete data set of images.

In one embodiment, the data sets may be medical image data sets. Accordingly, an object of interest may be a specific anatomical structure or region contained within the image data. A plurality of medical image data sets may be utilized. The images may include computed tomography (CT), magnetic resonance, x-ray, ultrasound, PET (positron emission tomography), and/or other medical images. Two or more similar data sets may be used to permit comparison of similar types of images taken at different times. For instance, two or more sets of CT images acquired at different times may be displayed next to one another to facilitate comparison. Other types of medical images may be compared.

Diagnosis may be performed using the images generated from the data sets. Searches for lesions, tumors, and/or other medical anomalies may be performed by “leafing through” the two or three dimensional images contained in the data sets. The leafing through operation may permit a user to view the images in a fourth dimension as well, i.e., time. If a suspicious structure is located, a subset of the data associated with a corresponding anatomical region or a particular organ may be used during further processing and for generating the ensuing display(s).

### I. Exemplary Embodiments

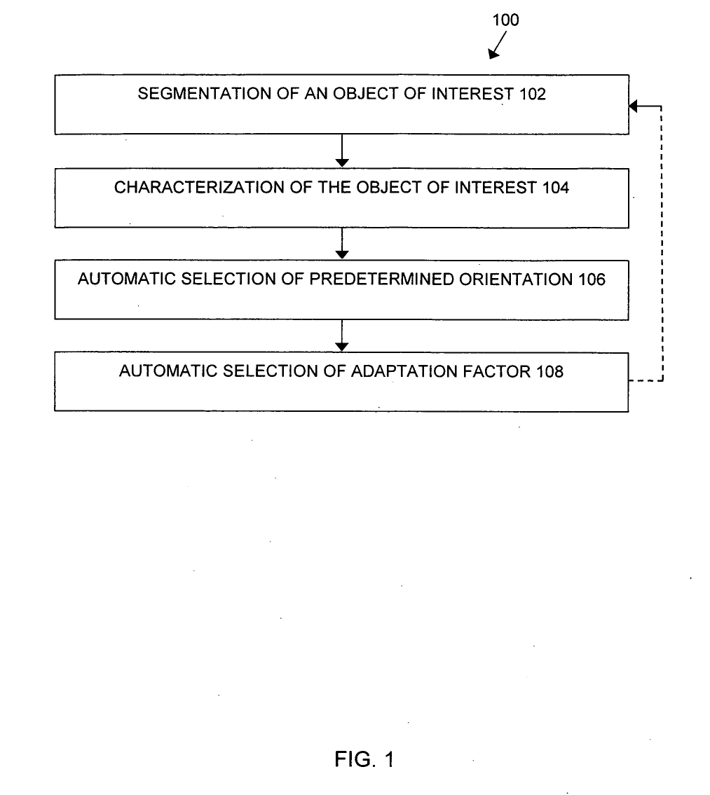

An exemplary method of automatic image visualization of objects of interest via a display 100 is illustrated in FIG. 1. The method 100 may include segmentation of an object of interest 102, characterization of the object of interest 104, selection of a predetermined or preferred orientation 106, and automatic selection of an image adaptation factor 108. The method of automatic image visualization may include additional, fewer, or alternate actions. One or more of the actions may be repeated.

The segmentation of an object of interest 102 may include graphically or otherwise selecting a certain object of interest within one or more images. The images may be from the same data set. Alternatively, the images used may be derived from a plurality of data sets containing images of the same object of interest. The selection of the object of interest may be approximate or precise, such as defined by x, y, and/or z coordinates. The selection of the object of interest may be performed by a user or automatically by a processor. For instance, in addition to the manual selection of a specific anatomical structure, e.g., an organ, an automatic organ detection algorithm may be started that searches for the required structure(s) with or without the use of an anatomic atlas.

For example, graphical selection of an object of interest may be performed by a user operating a mouse or other input device. A user interface may be operable to permit the user to manually move a cursor that is superimposed over a first display showing an image containing the object of interest. The user may then select an object of interest shown within the image via the mouse or other input device. The user may define the extent of a region of interest (such as by coordinates) via the mouse or other input device by selecting one corner of a box, such as by clicking to define a lower left hand corner, and then selecting another corner of the box, such as by clicking to define an upper right hand corner. Alternatively, a user may click directly upon a structure of interest to select it. Other input devices may be used, such as a touch screen operable to accept commands via the user touching the display directly. After the object of interest has been selected, the object may be displayed at the standard view as discussed herein.

Segmentation algorithms, such as “region growing,” may separate the image pixels and/or voxels associated with the object of interest from the surrounding pixels and/or voxels. The object of interest selected to be segmented may be an anatomical region or structure, such as an entire organ, an organ part, an organ structure, a diseased area, or other region. An entire organ may be the heart, an intestine, a lung, a kidney, a liver, or other organ. An organ part may be an individual vessel, a heart valve, a lung lobe, or other organ component. An organ structure may be a vertebra, a tooth, or other structure. A diseased area may be a tumor, a stenosis, or other unhealthy area. Models, machine taught or other classifiers may be used to segemt or identify the object of interest.

After segmentation, the method may include characterizing the object of interest 104. The object of interest may be a region of or a structure displayed within an image. In one embodiment, characterization of the object of interest 104 may ascertain an anatomical region or structure contained within a set of images, such as by type.

The process of characterizing the object may be achieved by one or more pattern recognition algorithms performed upon one or more image data sets. Anatomical atlases may be used in conjunction with a pattern recognition algorithm to facilitate the automatic identification of the object of interest. If an object of interest is unable to be accurately identified automatically, the user may visually identify an object contained within the image(s) and subsequently enter appropriate commands to a data processing system identifying that object. However, the use of a plurality of image data sets containing images of the same object of interest, such as the same anatomical region or structure, may facilitate the automatic identification of the object of interest and increase the success rate of the pattern recognition algorithm(s) employed.

In accordance with the characterization of an object of interest, the method may include selecting a predetermined or preferred orientation at which to display the object 106. Predetermined orientations at which to display the images corresponding to a specific object of interest may be selected and stored in a memory. A predetermined orientation may be the same or different from a current orientation being displayed.

As noted above, images of an object of interest may be contained in a plurality of data sets. Accordingly, multiple types of standard views for a plurality of data sets associated with an object of interest may be derived, such as a different standard view for each data set. Each standard view may have a corresponding predetermined orientation.

Alternatively, one standard view for the object of interest may be generated from the plurality of data sets, such as one view showing the object of interest from approximately the same viewpoint or at a similar orientation. By deriving one standard view for a plurality of image sets that contain images of the same object of interest, inefficiencies associated with conventional systems may be alleviated. For instance, conventional systems may require numerous user commands to be manually entered to orient one or more images of the object of interest to a desired orientation. Additionally, if more than one image of the object of interest is to be displayed simultaneously, such as within a plurality of windows on a display, one or more of the images may have to be manually rotated to display the images at the same orientation and facilitate comparison.

In one embodiment, the images displayed are medical images. Various axes may be determined within tubular bodily structures, such as vessels, certain bones, hollow organs, or other structures. In many anatomical structures, the axes are curved. The axis of the spine, for instance, has a curvature that may be defined by numerous planes passing through the spine itself or corresponding verticals. Accordingly, the rotational angle associated with a visualization of specific images may depend upon the position of the spine that is currently being visualized on a display, as an axis may change abruptly from one vertebra to another.

Conversely, within the large intestine, there is a continuous change of the corresponding axis. Kinks and loops of the large intestine also may be accounted for. As such, the image visualization may automatically display an image perpendicular to the axial location or images rotated about an axis.

Furthermore, with joints, such as knee joints, two axes may be defined by the lower and upper leg bones. In motion studies, which may involve four dimensional data sets, the axial location may change. Hence, the orientation of the images visualized may be time-dependent.

In the case of hip replacements, the angle between the upper leg bone and the hip socket may be a measure that estimates the durability of the replacement. The angle may be determined both before and after the hip replacement operation for preventive planning and quality control.

Organs may be sub-divided into lobes and segments, such as the liver and the lungs. The boundaries of the lobes of the lung may be at least partly visible (fissures) within the image data sets. The boundaries of the liver and the lung segments may be determined by segmentation of vessels and/or bronchi. Thus, the segment boundaries may be associated with main vessels and/or main bronchi.

After the segment boundaries have been defined, image visualization may be performed, such as image visualization perpendicular to an anatomical surface. Image visualization perpendicular to an anatomical surface may be used during the diagnosis of tumors. For instance, whether a tumor may be clearly demarcated to being located only on one side of a segment boundary, or whether the tumor has already grown into a neighboring segment, may be of interest. As a result of the image visualization and the size of a tumor being displayed, the diseased segments may be properly identified for treatment.

Objects of interest may be displayed at other predetermined orientations. For example, predetermined orientations may be organ-dependent visualizations corresponding to the access routes used during medical procedures or noninvasive interventions, such as biopsies or high-frequency ablations. Exemplary predetermined orientations corresponding to specific anatomical structures, which may be stored in and subsequently accessed from a memory, are listed in TABLE I below. Other tables of predetermined orientations corresponding to objects of interest may be used.

TABLE I

| Anatomical Structure | Predetermined Orientation |
|---|---|
| Vessel | Axis |
| Bone | Axis |
| Heart | Long or short axis |
| Heart Valves | Plane of the heart valves |
| Intestines | Axis |
| Vertebra | Axis of the spine |
| Joint | Axes, defined by joint bones |
| Bladder | Relative to fluid surface |
| Bronchi | Axis |
| Tumors, cysts, lesions, polyps | Relative to maximum extent |
| Lung lobes, lung segments | Relative to fissures and lobe or segment |
| | boundaries |
| Liver | Relative to segment boundaries |
| Stenoses | Axis |
| Teeth | Plane of the jaw |

As shown in TABLE I, a vessel, a bone, an intestine, a bronchi, or a stenosis image may have a predetermined orientation along its corresponding axis. A heart image may have a predetermined orientation along its long or short axis. A heart valve image may have a predetermined orientation along the plane of the heart valve. A vertebra image may have a predetermined orientation along the axis of the spine. A joint image may have a predetermined orientation along an axis defined by the bones joined by the joint.

A bladder image may have a predetermined orientation relative to a fluid surface or a direction of fluid flow. A tumor, cyst, lesion, polyp, or other anatomical structure image may have a predetermined orientation relative to a maximum length of the corresponding tumor, cyst, lesion, polyp, or other anatomical structure. A lung lobe or segment may have a predetermined orientation relative to fissures and lobe or segment boundaries. A liver image may have a predetermined orientation relative to segment boundaries. A tooth image may have a predetermined orientation along the plane of the jaw. Other anatomical structures and/or predetermined orientations may be used.

For instance, user-selected orientations may satisfy user preferences. Selectable orientations may be selected by the user and stored in a memory with the image data. The user-selected, preferred orientations may subsequently be automatically employed during follow-up medical examinations and used to compare two or more sets of images, acquired at different times, corresponding to the same anatomical region or structure.

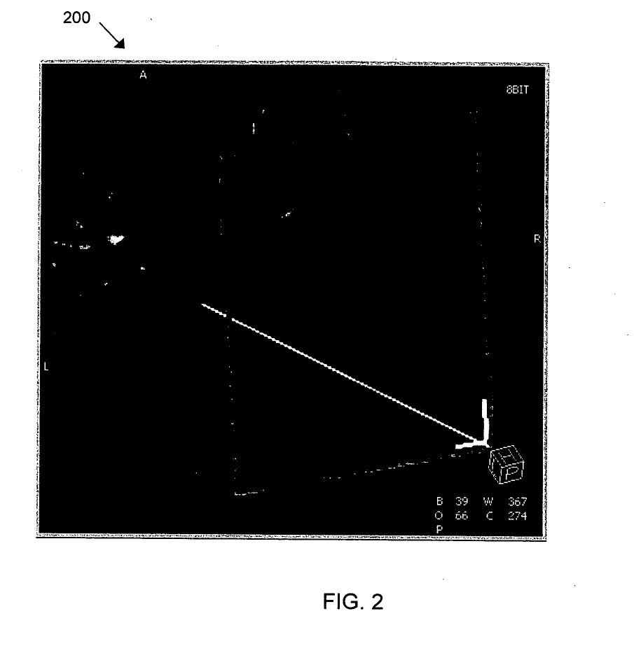

FIG. 2 illustrates an exemplary user interface 200 for image visualization. The user interface 200 may display one or more multi-dimensional images after the images have been received from an imaging device or retrieved from a memory. The viewing point of the image(s) displayed may be the center of or within a hollow organ, chamber, vessel or other object of interest to be visualized. The user interface 200 may present one or more images of the same object of interest. The system may first identify the object of interest represented within the image(s). Subsequently, a plurality of images of the object of interest displayed may all be automatically oriented along the same or approximately the same axis. Automatically orientating the images displayed in a number of windows to the same standard view may facilitate comparison of the images of the object of interest.

The method may include automatically selecting an adaptation factor 108. The adaptation factor automatically selected may resize the object of interest to enhance the resolution of the object to be displayed. For instance, a processor may automatically determine the type of the object of interest and resize the object based upon the type determined.

The processor may automatically determine the dimensions of the object of interest as shown within an image. Alternatively or simultaneously, the processor may automatically determine the dimensions of a display or a corresponding window within the display in which images of the object of interest are to be displayed. Based upon the dimensions of the object of interest and/or the display or corresponding window, the processor may automatically alter the size of the object and/or corresponding window to enhance the resolution of the object of interest once displayed without requiring user input, which may be inefficient, cumbersome, and inconvenient.

In one embodiment, before the object of interest is displayed within the display or a window, the processor may calculate an enlargement factor. The enlargement factor may be used by the processor to automatically adapt the size of the images of the object of interest more appropriately to the size of the display or window. The processor may use the enlargement factor to perform appropriate operations upon the image data to enhance the resolution of the images displayed, such as to multiply, increase, decrease, or otherwise change the size of the object of interest and/or corresponding window using the enlargement factor. Other operations also may be performed using the enlargement factor.

Other adaptation factors that alter the display of the images of the object of interest may be automatically determined. For instance, the contrast, brightness, or other display control settings associated with the display may be determined by a processor. The image data for one or more data sets may be analyzed by the processor using various algorithms to determine the level of corresponding contrast, brightness, and other visual aspects associated with the stored image data.

Based upon the visual aspects or characteristics of the image data, the contrast, brightness, or other display control settings may be automatically altered by the processor to enhance the resolution of the images displayed. Alternatively, the processor may perform operations on the image data to alter the visual aspects or characteristics of the data itself. Automatically accounting for the quality and characteristics of the stored image data and/or adjusting the control settings of the display may alleviate inefficiencies associated with conventional systems, which may require user input to alter image resolution.

In one embodiment, leafing through an image data set may be performed either along a fixed predetermined axis, such as a Cartesian patient coordinate system, or by means of the organ-dependent orientations described above. A desired anatomical structure may be displayed with maximum resolution by substantially filling up a display or corresponding window with as much of the anatomical structure as possible. For example, after segmentation of an anatomical region or structure, the maximum size of the anatomical region or structure may be determined. Subsequently, the axial position of the anatomical region or structure to be displayed and/or an enlargement factor may be determined accordingly.

The resolution of the imaging system itself may be taken into account in determining the proper maximum enlargement of a small object of interest. For instance, in some cases, further enlargement of a small object may start to or further degrade image resolution. Hence, thresholds may be automatically determined that limit the amount by which an object of interest may be enlarged, such as by limiting the size of the enlargement factor.

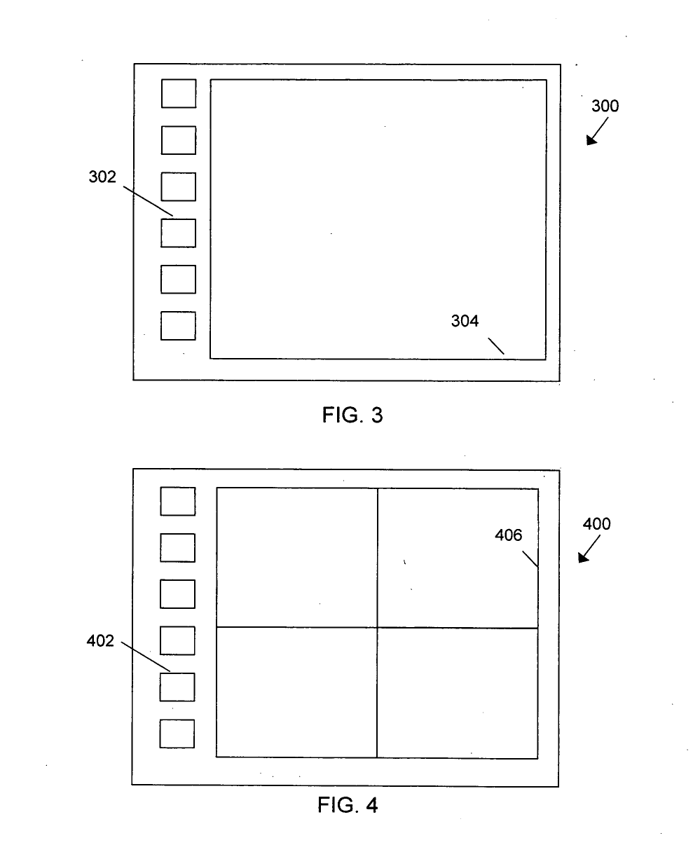

FIG. 3 illustrates an exemplary user interface for automatic image visualization. As shown, the user interface 300 may include one or more icons 302 and a primary window 304. The user interface 300 may include additional, fewer, or alternate components.

Each icon 302 shown in FIG. 3 may be associated with a different function or a specific data set. The primary window 304 may present image visualization as discussed herein. An operation performed on an icon 302, such as by a mouse, touch, or other input means, may result in the images displayed in the window 304 being changed to those associated with that icon 302. Accordingly, the images from a plurality of data sets may be displayed via a single display screen that employs a single user interface.

The user may select a specific object of interest to be displayed using the icons 302. Alternatively, the user may define the object of interest using a cursor superimposed over an image displayed or touching a touch screen. Other manners of selecting an object of interest may be used. Before the selected object of interest is to be displayed, the system may determine the dimensions of the object of interest contained within the corresponding data stored within an image data set. The system also may determine the dimensions of the primary window 304 in which the object of interest is to be displayed. The system may then determine an appropriate factor by which to multiple the size of the object of interest by to maximize the use of the available size of the primary window 304.

As a result, the resolution of the image of the object of interest displayed within the primary window 304 may be automatically enhanced. For instance, the object of interest may be resized to occupy most of or substantially all the viewable portion of the primary window 304. Hence, the inconvenience and inefficiencies associated with conventional systems that require the user to manual resize an object of interest to an appropriate size based upon the size of a window displayed may be alleviated.

In one embodiment, each enlargement factor determined may be stored in memory along with a corresponding data set. An enlargement factor associated with a first data set may be retrieved from the memory if a comparison is desired with a second data set containing images of the same object of interest as the first data set. During analysis of one or more data sets containing images of the same object of interest, such as data sets containing images acquired (1) using different contrast medium phases, (2) during examinations taken at different times, or (3) employing other modalities, the same enlargement factor may be used to facilitate comparison of the images. In other words, with a plurality of data sets containing images of the object of interest acquired at different times or via different means, the size of the object of interest stored within the data sets may be different and one of the data sets may be automatically resized such that all of the images of the object are approximately the same size.

As noted above, during a follow-up examination of a patient, two or more two data sets may be compared with one another. An original data set acquired during a previous examination and an updated data set acquired during a current examination may be compared. The data sets to be compared may be displayed at the same or a similar orientation. An orientation associated with the original data set may be adopted. However, with follow-up examinations, because the position of the patient is different, the patient has either gained or lost weight, or due to changes in the clinical picture, the location and/or shape of the object of interest may have changed. As a result, a new segmentation and/or a derivation of the orientation may be necessary.

For instance, if the spine is compared in two data sets along spine related axes, after the segmentation of the spine, the axes of the various data sets may first be determined separately from one another. Subsequently, a recording of the two axes may be performed. With this process, transformation matrices may be calculated. The matrices may include, for every point on the first axis, a corresponding or an equivalent point on the second axis. After which, images generated from the first data set may be leafed through along the first axis, and images generated from the second data set may be displayed next to the images generated from the first data set for ease of comparison.

FIG. 4 illustrates another exemplary user interface for image visualization. The user interface 400 may include a number of icons 402 and windows 406. The user interface 400 may include additional, fewer, or alternate components.

Each icon 402 may be associated with a different function or a specific data set. An operation performed on an icon 402 may result in the images displayed in all or some of the windows 406 being changed to those associated with that icon 402. Each window 406 may display images generated from a specific data set. Different images may be presented for side by side comparison. Accordingly, the images from different image data sets may be displayed via a single display screen that uses a single user interface simultaneously. The different image data sets may be acquired at different times or from different types of imaging devices.

The exemplary user interfaces of FIGS. 3 and 4 may provide functionality for rotating and/or translating along one or more axes of the two or three dimensional images received. The exemplary user interfaces may permit the images to be superimposed over one another to emphasize additional features, changes to the images, or other differences.

In one embodiment, the generation of multi-dimensional image visualization may be integrated into the process of initially reconstructing the images, rather than being performed subsequently, such as during post-processing. In such a situation, the parameters of the angle orientation and the image adaptation information associated with the reconstruction may be calculated and utilized. During image reconstruction, standard parameters may be used initially. After the segmentation and the extraction of the desired angles, another reconstruction may be performed with the adapted parameters. Then, during follow-up examinations, the parameters of the reconstruction of the first data set may be used initially.

### II. Exemplary Data Processor

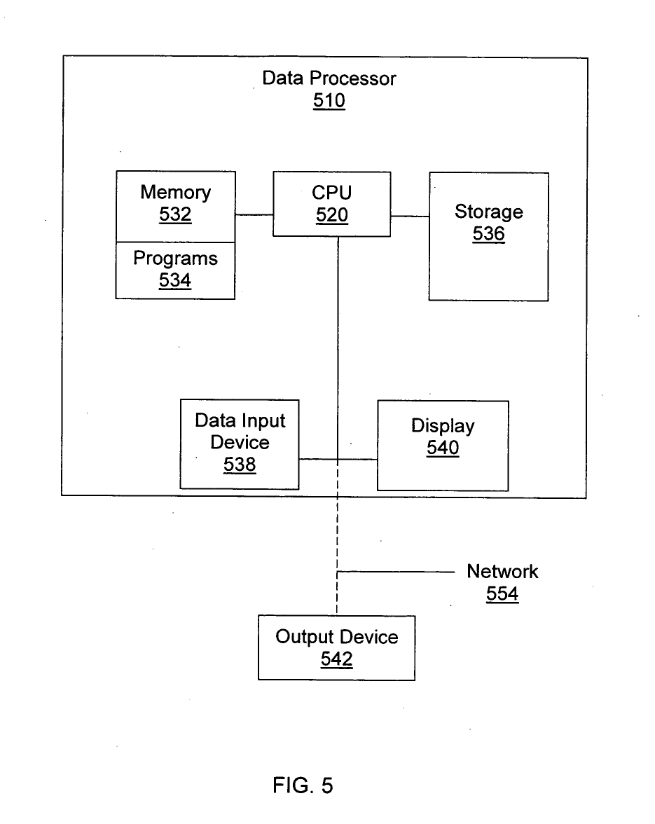

The method for image visualization may be facilitated by a data processing system. FIG. 5 is a block diagram of an exemplary data processor 510 configured or adapted to provide functionality for image visualization. The data processor 510 may include a central processing unit (CPU) 520, a memory 532, a storage device 536, a data input device 538, and a display 540. The data processor 510 also may have an external output device 542, which may be a display, a monitor, a printer or a communications port. The data processor 510 may be a personal computer, work station, server, medical imaging system, medical scanning system, or other system. The data processor 510 may be interconnected to a network 544, such as an intranet, the Internet, or an intranet connected to the Internet. The data processor 510 may be interconnected to another location via the network 544 either by data lines or by wireless communication. The data processor 510 is provided for descriptive purposes and is not intended to limit the scope of the present system. The data processor may have additional, fewer, or alternate components.

A program 534 may reside on the memory 532 and include one or more sequences of executable code or coded instructions that are executed by the CPU 520. The program 534 may be loaded into the memory 532 from the storage device 536 or network or removable media. The CPU 520 may execute one or more sequences of instructions of the program 534 to process data. The program 534 may provide functionality as discussed herein.

Image data may be entered via the data input device 538 or another input device, or received via the network 544 or other network. The data processor 510 may receive and store the image data received in the memory 532, the storage device 536, or other storage unit. The program 534 may direct that the data received be stored on or read from machine-readable medium, including secondary storage devices such as hard disks, floppy disks, CD-ROMS, and DVDs; electromagnetic signals; or other forms of machine readable medium, either currently known or later developed.

The program 534 may instruct the data processor 510 to render the images in one or more windows on the display 540, the external output device 542, or other display screen. The types of three dimensional rendering may include surface rendering, ray casting, minimum or maximum intensity projections or other renderings. The data processor 510 may retrieve the images from machine-readable medium, including secondary storage devices such as hard disks, floppy disks, CD-ROMS, and DVDs; electromagnetic signals; or other forms of machine readable medium, either currently known or later developed.

The program 534 may direct the data processor 510 to perform one or more navigation functions on the image data to scroll through or otherwise view the images in or out of sequence. The data processor 510 may display images and/or associated icons on the display 540, output device 542, or other display screen. A user interface may accept one or more operations performed on the images and/or associated icons to navigate through the images. For instance, the user interface may provide for the rotation of images and/or the translation along an axis of the images by clicking upon an image and/or associated icon and moving, i.e., “dragging,” the image and/or associated icon within the window with an input device, such as a mouse. Other operations may be performed.

While the invention has been described above by reference to various embodiments, it should be understood that many changes and modifications can be made without departing from the scope of the invention. The description and illustrations are by way of example only. Many more embodiments and implementations are possible within the scope of this invention and will be apparent to those of ordinary skill in the art. The various embodiments are not limited to the described environments and have a wide variety of applications.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

1. A data processing system for automatic image visualization, the system comprising:
a processor operable to characterize an object of interest shown within an image by type and automatically derive a standard view at which the object of interest is to be displayed based upon the type; and
a display screen operable to display the standard view of the object of interest.

2. The system of claim 1, wherein the image is a three dimensional medical image and the object of interest is an anatomical structure or region.

3. The system of claim 2, wherein the standard view includes the anatomical structure or region being orientated to a predetermined orientation based upon the type determined by the processor.

4. The system of claim 2, wherein the standard view includes the anatomical structure or region being orientated to a user-selected, preferred orientation based upon the type determined by the processor, the user-selected, preferred orientation being stored in and accessed from a memory.

5. The system of claim 1, wherein the image is associated with an image data set that contains a plurality of three dimensional images of the object of interest.

6. The system of claim 1, wherein the processor is operable to automatically resize the object of interest displayed based upon the size of the display screen or a window within which the object of interest is to be displayed.

7. The system of claim 1, wherein:
the display screen is operable to simultaneously display a plurality of images of the object of interest, acquired at different times, corresponding to substantially the same view of the object of interest; and
the processor is operable to automatically resize at least one of the plurality of images to facilitate comparison of the object of interest over time.

8. A method of automatic image visualization, the method comprising:
automatically deriving a standard view of an object of interest to be displayed from a plurality of image data sets, each of the plurality of image data sets including data from which images of the object of interest may be generated; and
displaying the standard view of the object of interest.

9. The method of claim 8, wherein the object of interest is an anatomical structure or region.

10. The method of claim 9, the method comprising classifying the anatomical structure or region by type based upon pattern recognition analysis of the plurality of image data sets, wherein the standard view includes an image of the anatomical structure or region being initially orientated to specific orientation based upon the type of the anatomical structure or region.

11. The method of claim 10, the method comprising automatically selecting an enlargement factor associated with the anatomical structure or region to enhance the resolution of the anatomical structure or region to be displayed.

12. The method of claim 8, wherein the standard view includes an image of the object of interest being initially orientated to a specific orientation based upon a type of the object of interest.

13. The method of claim 8, the method comprising:
automatically resizing the object of interest to be displayed based upon the size of the display screen or a corresponding window within which the object of interest is to be displayed; and
displaying the resized object of interest on the display screen or in the window.

14. The method of claim 8, the method comprising automatically resizing the object of interest to be displayed, wherein a resolution of the object of interest displayed is automatically enhanced without user input.

15. A method of automatic image visualization, the method comprising:
automatically characterizing an object of interest by type based upon corresponding image data;
automatically selecting a predetermined orientation of the object of interest at which the object of interest is to be displayed based upon the type; and
displaying the object of interest at the predetermined orientation.

16. The method of claim 15, wherein the object of interest is an anatomical structure or region.

17. The method of claim 15, the method comprising graphically selecting the object of interest to be characterized from a first display of the object of interest before (1) the predetermined orientation is automatically selected and (2) a second display of the object of interest at the predetermined orientation is generated.

18. The method of claim 15, the method comprising selecting an enlargement factor that is used to automatically adapt the size of the object of interest displayed.

19. The method of claim 15, the method comprising selecting an adaptation factor which is used to automatically adapt the image of the object of interest displayed to enhance the resolution of the image.

20. A computer-readable medium having instructions executable on a computer stored thereon, the instructions comprising:
determining the dimensions of an object of interest contained within image data; and
automatically resizing the object of interest based upon the dimensions determined before the object of interest is displayed on a display to enhance a resolution of the object of interest once displayed.

21. The computer-readable medium of claim 20, the instructions comprising determining a predetermined orientation of the object of interest at which to display the object of interest.

22. The computer-readable medium of claim 20, the instructions comprising classifying a type of the object of interest based upon pattern recognition analysis of a plurality of image data sets associated with the object of interest.
